(19) United States
(12) Patent Application Publication
(10) Pub. No.: US 2026/0084156 A1
(43) Pub. Date: Mar. 26, 2026

(54) INSERT AND CAP ASSEMBLY FOR TRANSMITTING ELECTROMAGNETIC WAVES AND METHODS OF USING THEREOF

(71) Applicant: INTEGRATED LINER TECHNOLOGIES, INC., Rensselaer, NY (US)

(72) Inventor: Paul PETROSINO, Slingerlands, NY (US)

(21) Appl. No.: 19/112,812

(22) PCT Filed: Sep. 26, 2023
(86) PCT No.: PCT/US2023/075106

§ 371 Date: Mar. 18, 2025

Related U.S. Application Data
(60) Provisional application No. 63/411,836, filed on Sep. 30, 2022.

(51) Int. Cl. B01L 3/00

(52) U.S. Cl. CPC B01L 3/5457; B01L 3/50825; B01L 2300/022; B01L 2300/042; B01L 2300/044

(57) ABSTRACT

The present disclosure provides for an insert for transmitting electromagnetic waves, the insert including: a substantially circular disc comprising a first surface and a second surface opposite and spaced apart from the first surface; and a lip extending from the disc and surrounding a perimeter of the disc; wherein the insert comprises a material that can be penetrated by a syringe. Also disclosed herein is a cap assembly including the insert as disclosed herein, a liner, and the cap, wherein the cap is coupled to the first surface of the insert and the liner is coupled to the second surface of the insert. Further provided herein is a cap and vial assembly, including the cap assembly as disclosed herein and a vial, wherein the cap assembly is configured to be secured to the vial. The present disclosure also provides for methods of using thereof, including a method of tracking a sample, and a method of analyzing a sample using an analytical instrument.

### CROSS-REFERENCE TO RELATED APPLICATIONS

This application claims the benefit of priority to, and the benefit of, U.S. Provisional Application No. 63/411,836 filed on Sep. 30, 2022, the disclosure of which is hereby expressly incorporated by reference herein in its entirety.

### BACKGROUND

Crimp caps are used to seal vials via a crimping mechanism. Often, crimp caps are sealed to a vial over a portion of a septum, such as a liner. Crimp caps are used in varying applications, such as chromatography, quality testing, and research and development, for example. RFID tags can be used in material handling processes to identify and record aspects about a sample and the container holding it. Further, RFID tags can be used with liners and caps in the applications discussed above. Currently, RFID tags cannot be used with a metal crimp cap at least because the metal of a crimp cap can interfere with the transmission of the radio frequency electromagnetic waves corresponding to the RFID tags, thus prohibiting the use of RFID tags in certain applications that utilize metal crimp caps.

The products and methods disclosed herein address these and other needs.

### SUMMARY

In accordance with the purposes of the disclosed materials and methods, as embodied and broadly described herein, the disclosed subject matter, in one aspect, relates to an insert.

Thus, in one example, an insert for transmitting electromagnetic is provided, the insert including a substantially circular disc comprising a first surface and a second surface opposite and spaced apart from the first surface; and a lip extending from the disc and surrounding a perimeter of the disc; wherein the insert comprises a material that can be penetrated by a syringe.

In a further example, a cap assembly is provided, including the insert as disclosed herein, a liner, and the cap, wherein the cap is coupled to the first surface of the insert and the liner coupled to the second surface of the insert.

Additionally, a cap and vial assembly is provided, including the cap assembly as disclosed herein and a vial, wherein the cap assembly is configured to be secured to the vial.

Also provided herein is a method of tracking a sample, wherein the sample is contained within a container comprising the cap assembly as disclosed herein, or the cap and vial assembly as disclosed herein, the method including entering sample identifying data into a database associated with the RFID tag, and scanning the RFID tag to obtain the sample identifying data, further wherein the liner comprises an RFID tag.

Also provided herein is a method of analyzing a sample using an analytical instrument, wherein the sample is contained within a container comprising the insert as disclosed herein, the assembly disclosed herein, or the cap and vial assembly as disclosed herein, the method including penetrating the liner with a syringe to remove a portion of the sample and testing the portion of the sample using the analytical instrument.

Additional advantages will be set forth in part in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

The accompanying figures, which are incorporated in and constitute a part of this specification, illustrate several aspects of the disclosure, and together with the description, serve to explain the principles of the disclosure.

FIGS. 1A-1E are perspective views of an example insert having no aperture.

FIGS. 2A-2B are perspective views of an example insert having an aperture.

FIGS. 3A-3D are an example cap having a diameter of approximately 20 mm.

FIGS. 4A-4B are perspective views of an example liner having one layer of thermoplastic polymer.

FIGS. 5A-5B are perspective views of an example liner having two layers of thermoplastic polymer.

FIGS. 6A-6J are exploded perspective views and perspective views of an example cap and vial assembly.

FIGS. 7A-7J are exploded perspective views and perspective views of an example cap and vial assembly, wherein the example liner comprises an RFID tag and has one layer of thermoplastic polymer.

FIGS. 8A-8J are exploded perspective views and perspective views of an example cap and vial assembly, wherein the example liner comprises an RFID tag and has two layers of thermoplastic polymer.

### DETAILED DESCRIPTION

The following description of the disclosure is provided as an enabling teaching of the disclosure in its best, currently known embodiments. Many modifications and other embodiments disclosed herein will come to mind to one skilled in the art to which the disclosed products and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As can be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed products and methods belong. It can be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

In this specification and in the claims that follow, reference will be made to a number of terms, which shall be defined to have the following meanings.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including.” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.”

As used in the specification and the appended claims, the singular forms “a,” “an” and “the” include plural referents unless the context clearly dictates otherwise. Thus, for example, reference to “a compound”, “a product”, or “a disorder”, includes, but is not limited to, one or more such compounds, products, or disorders, and the like.

It should be noted that ratios, concentrations, amounts, and other numerical data can be expressed herein in a range format. It can be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it can be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise. As used herein, the term “substantially free,” when used in the context of a product or component of a product that is substantially absent, is intended to refer to an amount that is then about 1% by weight or less, e.g., less than about 0.5% by weight, less than about 0.1% by weight, less than about 0.05% by weight, or less than about 0.01% by weight of the stated material, based on the total weight of the product.

As used herein, “cross-sectional shape” refers to the shape in a plane substantially perpendicular to the thickness, wherein “thickness” refers to the average dimension between opposite surfaces of an object.

The term “(co) polymer” includes homopolymers, copolymers, or mixtures thereof.

As used herein, “molecular weight” refers to number-average molecular weight as measured by ¹H NMR spectroscopy, unless clearly indicated otherwise.

### Chemical Definitions

Unless otherwise defined, all technical and scientific terms used herein have the same meaning as commonly understood by one of ordinary skill in the art to which this invention belongs.

The organic moieties mentioned when defining variable positions within the general formulae described herein (e.g., the term “halogen”) are collective terms for the individual substituents encompassed by the organic moiety. The prefix Cn-Cm preceding a group or moiety indicates, in each case, the possible number of carbon atoms in the group or moiety that follows.

The term “ion,” as used herein, refers to any molecule, portion of a molecule, cluster of molecules, molecular complex, moiety, or atom that contains a charge (positive, negative, or both at the same time within one molecule, cluster of molecules, molecular complex, or moiety (e.g., zwitterions)) or that can be made to contain a charge. Methods for producing a charge in a molecule, portion of a molecule, cluster of molecules, molecular complex, moiety, or atom are disclosed herein and can be accomplished by methods known in the art, e.g., protonation, deprotonation, oxidation, reduction, alkylation, acetylation, esterification, de-esterification, hydrolysis, etc.

The term “anion” is a type of ion and is included within the meaning of the term “ion.” An “anion” is any molecule, portion of a molecule (e.g., zwitterion), cluster of molecules, molecular complex, moiety, or atom that contains a net negative charge or that can be made to contain a net negative charge. The term “anion precursor” is used herein to specifically refer to a molecule that can be converted to an anion via a chemical reaction (e.g., deprotonation).

The term “cation” is a type of ion and is included within the meaning of the term “ion.” A “cation” is any molecule, portion of a molecule (e.g., zwitterion), cluster of molecules, molecular complex, moiety, or atom, that contains a net positive charge or that can be made to contain a net positive charge. The term “cation precursor” is used herein to specifically refer to a molecule that can be converted to a cation via a chemical reaction (e.g., protonation or alkylation).

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valencies of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc.

“Z¹,” “Z²,” “Z³,” and “Z⁴” are used herein as generic symbols to represent various specific substituents. These symbols can be any substituent, not limited to those disclosed herein, and when they are defined to be certain substituents in one instance, they can, in another instance, be defined as some other substituents.

The term “aliphatic” as used herein refers to a non-aromatic hydrocarbon group and includes branched and unbranched, alkyl, alkenyl, or alkynyl groups.

As used herein, the term “alkyl” refers to saturated, straight-chained or branched saturated hydrocarbon moieties. Unless otherwise specified, C₁-C₂₄ (e.g., C₁-C₂₂, C₁-C₂₀, C₁-C₁₈, C₁-C₁₆, C₁-C₁₄, C₁-C₁₂, C₁-C₁₀, C₁-C₈, C₁-C₆, or C₁-C₄) alkyl groups are intended. Examples of alkyl groups include methyl, ethyl, propyl, 1-methyl-ethyl, butyl, 1-methyl-propyl, 2-methyl-propyl, 1,1-dimethyl-ethyl, pentyl, 1-methyl-butyl, 2-methyl-butyl, 3-methyl-butyl, 2,2-dimethyl-propyl, 1-ethyl-propyl, hexyl, 1,1-dimethyl-propyl, 1,2-dimethyl-propyl, 1-methyl-pentyl, 2-methyl-pentyl, 3-methyl-pentyl, 4-methyl-pentyl, 1,1-dimethyl-butyl, 1,2-dimethyl-butyl, 1,3-dimethyl-butyl, 2,2-dimethyl-butyl, 2,3-dimethyl-butyl, 3,3-dimethyl-butyl, 1-ethyl-butyl, 2-ethyl-butyl, 1,1,2-trimethyl-propyl, 1,2,2-trimethyl-propyl, 1-ethyl-1-methyl-propyl, 1-ethyl-2-methyl-propyl, heptyl, octyl, nonyl, decyl, dodecyl, tetradecyl, hexadecyl, eicosyl, tetracosyl, and the like. Alkyl substituents may be unsubstituted or substituted with one or more chemical moieties. The alkyl group can be substituted with one or more groups including, but not limited to, hydroxyl, halogen, acetal, acyl, alkyl, alkoxy, alkenyl, alkynyl, aryl, heteroaryl, aldehyde, amino, cyano, carboxylic acid, ester, ether, carbonate ester, carbamate ester, ketone, nitro, phosphonyl, silyl, sulfo-oxo, sulfonyl, sulfone, sulfoxide, or thiol, as described below, provided that the substituents are sterically compatible and the rules of chemical bonding and strain energy are satisfied.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” or “haloalkyl” specifically refers to an alkyl group that is substituted with one or more halides (halogens; e.g., fluorine, chlorine, bromine, or iodine). The term “alkoxyalkyl” specifically refers to an alkyl group that is substituted with one or more alkoxy groups, as described below. The term “alkylamino” specifically refers to an alkyl group that is substituted with one or more amino groups, as described below, and the like. When “alkyl” is used in one instance and a specific term such as “alkylalcohol” is used in another, it is not meant to imply that the term “alkyl” does not also refer to specific terms such as “alkylalcohol” and the like.

This practice is also used for other groups described herein. That is, while a term such as “cycloalkyl” refers to both unsubstituted and substituted cycloalkyl moieties, the substituted moieties can, in addition, be specifically identified herein; for example, a particular substituted cycloalkyl can be referred to as, e.g., an “alkylcycloalkyl.” Similarly, a substituted alkoxy can be specifically referred to as, e.g., a “halogenated alkoxy,” a particular substituted alkenyl can be, e.g., an “alkenylalcohol,” and the like. Again, the practice of using a general term, such as “cycloalkyl,” and a specific term, such as “alkylcycloalkyl,” is not meant to imply that the general term does not also include the specific term.

As used herein, the term “alkenyl” refers to unsaturated, straight-chained, or branched hydrocarbon moieties containing a double bond. Unless otherwise specified, C₂-C₂₄ (e.g., C₂-C₂₂, C₂-C₂₀, C₂-C₁₈, C₂-C₁₆, C₂-C₁₄, C₂-C₁₂, C₂-C₁₀, C₂-C₈, C₂-C₆, or C₂-C₄) alkenyl groups are intended. Alkenyl groups may contain more than one unsaturated bond. Examples include ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, I-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl. 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl. 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, and 1-ethyl-2-methyl-2-propenyl. The term “vinyl” refers to a group having the structure —CH═CH₂; 1-propenyl refers to a group with the structure —CH═CH—CH₃; and 2-propenyl refers to a group with the structure —CH₂—CH═CH₂. Asymmetric structures such as (Z¹Z²)C═C(Z³Z⁴) are intended to include both the E and Z isomers. This can be presumed in structural formulae herein wherein an asymmetric alkene is present, or it can be explicitly indicated by the bond symbol C═C. Alkenyl substituents may be unsubstituted or substituted with one or more chemical moieties. Examples of suitable substituents include, for example, alkyl, alkoxy, alkenyl, alkynyl, aryl, heteroaryl, acetal, acyl, aldehyde, amino, cyano, carboxylic acid, ester, ether, carbonate ester, carbamate ester, halide, hydroxyl, ketone, nitro, phosphonyl, silyl, sulfo-oxo, sulfonyl, sulfone, sulfoxide, or thiol, as described below, provided that the substituents are sterically compatible and the rules of chemical bonding and strain energy are satisfied.

As used herein, the term “alkynyl” represents straight-chained or branched hydrocarbon moieties containing a triple bond. Unless otherwise specified, C₂-C₂₄ (e.g., C₂-C₂₄, C₂-C₂₀, C₂-C₁₈, C₂-C₁₆, C₂-C₁₄, C₂-C₁₂, C₂-C₁₀, C₂-C₈, C₂-C₆, or C₂-C₄) alkynyl groups are intended. Alkynyl groups may contain more than one unsaturated bond. Examples include C₂-C₆-alkynyl, such as ethynyl, 1-propynyl, 2-propynyl (or propargyl), 1-butynyl, 2-butynyl, 3-butynyl, 1-methyl-2-propynyl, 1-pentynyl, 2-pentynyl, 3-pentynyl, 4-pentynyl, 3-methyl-1-butynyl, 1-methyl-2-butynyl, 1-methyl-3-butynyl, 2-methyl-3-butynyl, 1,1-dimethyl-2-propynyl, 1-ethyl-2-propynyl, 1-hexynyl, 2-hexynyl, 3-hexynyl, 4-hexynyl. 5-hexynyl, 3-methyl-1-pentynyl, 4-methyl-1-pentynyl, 1-methyl-2-pentynyl, 4-methyl-2-pentynyl, 1-methyl-3-pentynyl, 2-methyl-3-pentynyl. 1-methyl-4-pentynyl, 2-methyl-4-pentynyl, 3-methyl-4-pentynyl. 1,1-dimethyl-2-butynyl, 1,1-dimethyl-3-butynyl, 1,2-dimethyl-3-butynyl, 2,2-dimethyl-3-butynyl, 3,3-dimethyl-1-butynyl. 1-ethyl-2-butynyl, 1-ethyl-3-butynyl, 2-ethyl-3-butynyl, and 1-ethyl-1-methyl-2-propynyl. Alkynyl substituents may be unsubstituted or substituted with one or more chemical moieties. Examples of suitable substituents include, for example, alkyl, alkoxy, alkenyl, alkynyl, aryl, heteroaryl, acetal, acyl, aldehyde, amino, cyano, carboxylic acid, ester, ether, carbonate ester, carbamate ester, halide, hydroxyl, ketone, nitro, phosphonyl, silyl, sulfo-oxo, sulfonyl, sulfone, sulfoxide, or thiol, as described below.

As used herein, the term “aryl,” as well as derivative terms such as aryloxy, refers to groups that include a monovalent aromatic carbocyclic group of from 3 to 50 carbon atoms. Aryl groups can include a single ring or multiple condensed rings. In some embodiments, aryl groups include C₆-C₁₀ aryl groups. Examples of aryl groups include, but are not limited to, benzene, phenyl, biphenyl, naphthyl, tetrahydronaphthyl, phenylcyclopropyl, phenoxybenzene, and indanyl. The term “aryl” also includes “heteroaryl,” which is defined as a group that contains an aromatic group that has at least one heteroatom incorporated within the ring of the aromatic group. Examples of heteroatoms include, but are not limited to, nitrogen, oxygen, sulfur, and phosphorus. The term “non-heteroaryl,” which is also included in the term “aryl,” defines a group that contains an aromatic group that does not contain a heteroatom. The aryl substituents may be unsubstituted or substituted with one or more chemical moieties. Examples of suitable substituents include, for example, alkyl, alkoxy, alkenyl, alkynyl, aryl, heteroaryl, acetal, acyl, aldehyde, amino, cyano, carboxylic acid, ester, ether, carbonate ester, carbamate ester, halide, hydroxyl, ketone, nitro, phosphonyl, silyl, sulfo-oxo, sulfonyl, sulfone, sulfoxide, or thiol as described herein. The term “biaryl” is a specific type of aryl group and is included in the definition of aryl. Biaryl refers to two aryl groups that are bound together via a fused ring structure, as in naphthalene, or are attached via one or more carbon-carbon bonds, as in biphenyl.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, etc. The term “heterocycloalkyl” is a cycloalkyl group as defined above where at least one of the carbon atoms of the ring is substituted with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, alkyl, alkoxy, alkenyl, alkynyl, aryl, heteroaryl, acetal, acyl, aldehyde, amino, cyano, carboxylic acid, ester, ether, carbonate ester, carbamate ester, halide, hydroxyl, ketone, nitro, phosphonyl, silyl, sulfo-oxo, sulfonyl, sulfone, sulfoxide, or thiol as described herein.

The term “cycloalkenyl” as used herein is a non-aromatic carbon-based ring composed of at least three carbon atoms and containing at least one double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, and the like. The term “heterocycloalkenyl” is a type of cycloalkenyl group as defined above and is included within the meaning of the term “cycloalkenyl,” where at least one of the carbon atoms of the ring is substituted with a heteroatom such as, but not limited to, nitrogen, oxygen, sulfur, or phosphorus. The cycloalkenyl group and heterocycloalkenyl group can be substituted or unsubstituted. The cycloalkenyl group and heterocycloalkenyl group can be substituted with one or more groups including, but not limited to, alkyl, alkoxy, alkenyl, alkynyl, aryl, heteroaryl, acetal, acyl, aldehyde, amino, cyano, carboxylic acid, ester, ether, carbonate ester, carbamate ester, halide, hydroxyl, ketone, nitro, phosphonyl, silyl, sulfo-oxo, sulfonyl, sulfone, sulfoxide, or thiol as described herein.

The term “cyclic group” is used herein to refer to either aryl groups, non-aryl groups (i.e., cycloalkyl, heterocycloalkyl, cycloalkenyl, and heterocycloalkenyl groups), or both. Cyclic groups have one or more ring systems (e.g., monocyclic, bicyclic, tricyclic, polycyclic, etc.) that can be substituted or unsubstituted. A cyclic group can contain one or more aryl groups, one or more non-aryl groups, or one or more aryl groups and one or more non-aryl groups.

The term “acyl” as used herein is represented by the formula —C(O)Z¹ where Z¹ can be a hydrogen, hydroxyl, alkoxy, alkyl, alkenyl, alkynyl, aryl, heteroaryl, cycloalkyl, cycloalkenyl, heterocycloalkyl, or heterocycloalkenyl group described above. As used herein, the term “acyl” can be used interchangeably with “carbonyl.” Throughout this specification “C(O)” or “CO” is a shorthand notation for C═O.

The term “acetal” as used herein is represented by the formula (Z¹Z²)C(═OZ³)(═OZ⁴), where Z¹, Z², Z³, and Z⁴ can be, independently, a hydrogen, halogen, hydroxyl, alkyl, alkenyl, alkynyl, aryl, heteroaryl, cycloalkyl, cycloalkenyl, heterocycloalkyl, or heterocycloalkenyl group described above.

The term “alkanol” as used herein is represented by the formula Z¹OH, where Z¹ can be an alkyl, alkenyl, alkynyl, aryl, heteroaryl, cycloalkyl, cycloalkenyl, heterocycloalkyl, or heterocycloalkenyl group described above.

As used herein, the term “alkoxy” as used herein is an alkyl group bound through a single, terminal ether linkage; that is, an “alkoxy” group can be defined as to a group of the formula Z¹—O—, where Z¹ is unsubstituted or substituted alkyl as defined above. Unless otherwise specified, alkoxy groups wherein Z¹ is a C₁-C₂₄ (e.g., C₁-C₂₂, C₁-C₂₀, C₁-C₁₈, C₁-C₁₆, C₁-C₁₄, C₁-C₁₂, C₁-C₁₀, C₁-C₈, C₁-C₆, or C₁-C₄) alkyl group are intended. Examples include methoxy, ethoxy, propoxy, 1-methyl-ethoxy, butoxy, 1-methyl-propoxy, 2-methyl-propoxy, 1,1-dimethyl-ethoxy, pentoxy, 1-methyl-butyloxy, 2-methyl-butoxy, 3-methyl-butoxy, 2,2-di-methyl-propoxy, 1-ethyl-propoxy, hexoxy, 1,1-dimethyl-propoxy, 1,2-dimethyl-propoxy, 1-methyl-pentoxy, 2-methyl-pentoxy, 3-methyl-pentoxy, 4-methyl-penoxy, 1,1-dimethyl-butoxy, 1,2-dimethyl-butoxy, 1,3-dimethyl-butoxy, 2,2-dimethyl-butoxy, 2,3-dimethyl-butoxy, 3,3-dimethyl-butoxy, 1-ethyl-butoxy, 2-ethylbutoxy, 1,1,2-trimethyl-propoxy, 1,2,2-trimethyl-propoxy, 1-ethyl-1-methyl-propoxy, and 1-ethyl-2-methyl-propoxy.

The term “aldehyde” as used herein is represented by the formula —C(O)H. Throughout this specification “C(O)” is a shorthand notation for C═O.

The terms “amine” or “amino” as used herein are represented by the formula —NZ¹Z²Z³, where Z¹, Z², and Z³ can each be substitution group as described herein, such as hydrogen, an alkyl, alkenyl, alkynyl, aryl, heteroaryl, cycloalkyl, cycloalkenyl, heterocycloalkyl, or heterocycloalkenyl group described above.

The terms “amide” or “amido” as used herein are represented by the formula —C(O)NZ¹Z², where Z¹ and Z² can each be substitution group as described herein, such as hydrogen, an alkyl, alkenyl, alkynyl, aryl, heteroaryl, cycloalkyl, cycloalkenyl, heterocycloalkyl, or heterocycloalkenyl group described above.

The term “anhydride” as used herein is represented by the formula Z¹C(O)OC(O)Z² where Z¹ and Z², independently, can be an alkyl, alkenyl, alkynyl, aryl, heteroaryl, cycloalkyl, cycloalkenyl, heterocycloalkyl, or heterocycloalkenyl group described above.

The term “cyclic anhydride” as used herein is represented by the formula:

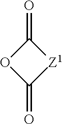

where Z¹ can be an alkyl, alkenyl, alkynyl, aryl, heteroaryl, cycloalkyl, cycloalkenyl, heterocycloalkyl, or heterocycloalkenyl group described above.

The term “azide” as used herein is represented by the formula —N═N═N.

The term “carboxylic acid” as used herein is represented by the formula —C(O)OH.

A “carboxylate” or “carboxyl” group as used herein is represented by the formula —C(O)O.

A “carbonate ester” group as used herein is represented by the formula Z¹OC(O)OZ².

The term “cyano” as used herein is represented by the formula —CN.

The term “ester” as used herein is represented by the formula —OC(O)Z¹ or —C(O)OZ¹, where Z¹ can be an alkyl, alkenyl, alkynyl, aryl, heteroaryl, cycloalkyl, cycloalkenyl, heterocycloalkyl, or heterocycloalkenyl group described above.

The term “ether” as used herein is represented by the formula Z¹OZ², where Z¹ and Z² can be, independently, an alkyl, alkenyl, alkynyl, aryl, heteroaryl, cycloalkyl, cycloalkenyl, heterocycloalkyl, or heterocycloalkenyl group described above.

The term “epoxy” or “epoxide” as used herein refers to a cyclic ether with a three atom ring and can represented by the formula:

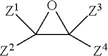

where Z¹, Z², Z³, and Z⁴ can be, independently, an alkyl, alkenyl, alkynyl, aryl, heteroaryl, cycloalkyl, cycloalkenyl, heterocycloalkyl, or heterocycloalkenyl group described above

The term “ketone” as used herein is represented by the formula Z¹C(O)Z², where Z¹ and Z² can be, independently, an alkyl, alkenyl, alkynyl, aryl, heteroaryl, cycloalkyl, cycloalkenyl, heterocycloalkyl, or heterocycloalkenyl group described above.

The term “halide” or “halogen” or “halo” as used herein refers to fluorine, chlorine, bromine, and iodine.

The term “hydroxyl” as used herein is represented by the formula —OH.

The term “nitro” as used herein is represented by the formula —NO₂.

The term “phosphonyl” is used herein to refer to the phospho-oxo group represented by the formula —P(O)(OZ¹)₂, where Z¹ can be hydrogen, an alkyl, alkenyl, alkynyl, aryl, heteroaryl, cycloalkyl, cycloalkenyl, heterocycloalkyl, or heterocycloalkenyl group described above.

The term “silyl” as used herein is represented by the formula —SiZ¹Z²Z³, where Z¹, Z², and Z³ can be, independently, hydrogen, alkyl, alkoxy, alkenyl, alkynyl, aryl, heteroaryl, cycloalkyl, cycloalkenyl, heterocycloalkyl, or heterocycloalkenyl group described above.

The term “sulfonyl” or “sulfone” is used herein to refer to the sulfo-oxo group represented by the formula —S(O)₂Z¹, where Z¹ can be hydrogen, an alkyl, alkenyl, alkynyl, aryl, heteroaryl, cycloalkyl, cycloalkenyl, heterocycloalkyl, or heterocycloalkenyl group described above.

The term “sulfide” as used herein is comprises the formula —S—.

The term “thiol” as used herein is represented by the formula —SH.

“R¹,” “R²,” “R³,” “Rⁿ,” etc., where n is some integer, as used herein can, independently, possess one or more of the groups listed above. For example, if R¹ is a straight chain alkyl group, one of the hydrogen atoms of the alkyl group can optionally be substituted with a hydroxyl group, an alkoxy group, an amine group, an alkyl group, a halide, and the like. Depending upon the groups that are selected, a first group can be incorporated within second group or, alternatively, the first group can be pendant (i.e., attached) to the second group. For example, with the phrase “an alkyl group comprising an amino group,” the amino group can be incorporated within the backbone of the alkyl group. Alternatively, the amino group can be attached to the backbone of the alkyl group. The nature of the group(s) that is (are) selected will determine if the first group is embedded or attached to the second group.

Unless stated to the contrary, a formula with chemical bonds shown only as solid lines and not as wedges or dashed lines contemplates each possible stereoisomer or mixture of stereoisomer (e.g., each enantiomer, each diastereomer, each meso compound, a racemic mixture, or scalemic mixture).

### Products

The insert (100, 1100) disclosed herein presents a number of advantages and benefits. The use of an insert (100, 1100) allows for use of a liner (300) comprising an RFID tag (306) in a cap assembly (500) that includes a cap (200). The metal of the crimp cap interferes with the RF EM waves and therefore, previous users of metal crimp cap assemblies could not use liners comprising RFID tags. The insert (100, 1100) remedies this issue in that it covers the liner with a material transmissive of RF EM waves, instead of metal. Thus, applications and industries that utilize metal crimp caps can now also incorporate liners comprising RFID tags into the cap assemblies because of the insert (100, 1100).

Further, the insert (100, 1100) prevents aluminum dust from contaminating the sample. With the insert (100, 1100), the material surrounding the area of the liner (300) subject to penetration by the syringe is not the aluminum from the cap, but rather the material of the insert (100, 1100), thus preventing contamination from aluminum dust, as well as any other contaminant.

Additionally, the insert (100, 1100) provides rigid support for crimping the cap (200) to a vial (400).

### Insert

Provided herein is an insert (100, 1100) for transmitting electromagnetic waves, the insert (100, 1100) comprising a substantially circular disc comprising a first surface and a second surface opposite and spaced apart from the first surface; and a lip extending from the disc and surrounding a perimeter of the disc; wherein the insert (100, 1100) comprises a material that can be penetrated by a syringe.

As used herein, “lip” refers to a projecting edge. The lip can extend from a surface or an object and in some examples, can extend such that it is substantially perpendicular to the object from which it extends. The lip can have varying lengths.

In some examples, the insert (100, 1100) has a Shore D Hardness of from 20 to 80. In further examples, the insert (100, 1100) has a Shore D Hardness of from 20 to 30, 30 to 40, 40 to 50, 50 to 60, 60 to 70, or 70 to 80. In certain examples, the insert (100, 1100) has a Shore D Hardness of from 20 to 40, 20 to 50, 20 to 60, or 20 to 70. In specific examples, the insert (100, 1100) has a Shore D Hardness of from 20 to 35, 35 to 50, 50 to 65, or 65 to 80. In some examples, the insert (100, 1100) has a Shore D Hardness of from 20 to 26, 26 to 32, 32 to 38, 38 to 44, 44 to 50, 50 to 56, 56 to 62, 62 to 68, 68 to 74, or 74 to 80.

Shore Hardness is a measure of the resistance a material has to indentation. There are different Shore Hardness scales for measuring the hardness of different materials (e.g., soft rubbers, rigid plastics, and supersoft gels). The Shore 00 Hardness Scale measures rubbers and gels that are very soft. The Shore A Hardness Scale measures the hardness of flexible mold rubbers that range in hardness from very soft and flexible, to medium and somewhat flexible, to hard with almost no flexibility at all. Semi-rigid plastics can also be measured on the high end of the Shore A Scale. Shore D Hardness Scale measured the hardness of hard rubbers, semi-rigid plastics, and hard plastics. Shore Hardness is measured with a “Shore Hardness” gauge, which has a needle on a spring protruding from one end; to measure the Shore Hardness with said gauge, the needle is placed against the rubber or plastic and pressure is applied.

In some examples, the insert (100, 1100) further comprises an aperture (102), the aperture extending through the substantially circular disc from the first surface to the second surface. In further examples, the aperture (102) has a cross-sectional shape that is substantially circular. As used herein, aperture (102) refers to perforations or through holes, wherein through holes extend through the entire thickness of the insert (100, 1100).

In some examples, the aperture (102) has an area of from 10% to 80% of the area of the first surface. In certain examples, the aperture (102) has an area of from 10% to 45%, or 45% to 80% of the first surface. In specific examples, the aperture (102) has an area of from 10% to 30%, 10% to 50%, or 10% to 70% of the first surface. In some examples, the aperture (102) has an area of from 10% to 20%, 20% to 30%, 30% to 40%, 40% to 50%, 50% to 60%, 60% to 70%, or 70% to 80% of the first surface. In further examples, the aperture (102) has an area of from 10% to 25%, 10% to 35%, 10% to 45%, 10% to 55%, 10% to 65%, or 10% to 75% of the first surface. In certain examples, the aperture (102) has an area of from 25% to 35%, 25% to 45%, 45% to 55%, 55% to 65%, or 65% to 75% of the first surface.

In some examples, the aperture has an average characteristic dimension of from 0 millimeters (mm) to 16 mm. In further examples, the aperture has an average characteristic dimension of from 0 to 2 mm, 2 mm to 4 mm, 4 mm to 6 mm, 6 mm to 8 mm, 8 mm to 10 mm, 10 mm to 12 mm, 12 mm to 14 mm, or 14 mm to 16 mm. In certain examples, the aperture has an average characteristic dimension of from 0 mm to 4 mm, 0 mm to 6 mm, 0 mm to 8 mm, 0 mm to 10 mm, 0 mm to 12 mm, 0 mm to 14 mm, or 0 mm to 16 mm. In specific examples, the aperture has an average characteristic dimension of from 4 mm to 8 mm, 8 mm to 12 mm, or 12 mm to 16 mm.

In some examples, the insert (100, 1100) is a single continuous structure comprising the disc and the lip. In further examples, the lip is substantially perpendicular to the first surface of the disc. In certain examples, a thickness of the disc varies across the diameter. In specific examples, the insert (100, 1100) has an average thickness of from 0.1 mm to 0.5 mm. In some examples, the insert (100, 1100) has an average thickness of from 0.1 mm to 0.2 mm, 0.2 mm to 0.3 mm, 0.3 mm to 0.4 mm, or 0.4 mm to 0.5 mm. In further examples, the insert (100, 1100) has an average thickness of from 0.1 mm to 0.3 mm, or 0.1 mm to 0.4 mm. In specific examples, the insert (100, 1100) has an average thickness of from 0.1 mm to 0.25 mm, or 0.25 mm to 0.5 mm. In some examples, the lip is integrally formed with the disc.

The first surface can be planar or non-planar. In some examples, the first surface is non-planar. For example, the first surface can comprise a first portion and a second portion, the second portion of the first surface being in a different plane than the first surface. For example, the second portion can be in an elevated plane relative to the first portion. In further examples, the second portion is in an elevated plane, wherein the second portion is centered in the first surface of the insert (100, 1100) (e.g., when the insert, the first portion, and the second portion are each circular, the first portion and the second portion can be concentric). In certain examples, the aperture (102) is centered in, or concentric with, the second portion of the first surface.

In some examples, the material is transmissive to radio frequency electromagnetic waves. In further examples, the insert (100, 1100) has a transmissivity to radio frequency electromagnetic waves. Transmissivity refers to the ability of a material to allow something, in particular electromagnetic radiation, to pass through it. Herein, a material comprising transmissivity (e.g., a material that is transmissive) to radio frequency (RF) electromagnetic (EM) waves allows for RF EM waves to pass through the material.

Radio frequency (RF) electromagnetic (EM) waves, or radio frequency electromagnetic radiation, refers to the transmission of energy by radio waves. RF EM waves have a frequency of from 10 kilohertz (kHz) to 300 gigahertz (GHz). RF EM waves are non-ionizing radiation, and therefore do not have sufficient energy to break chemical bonds or remove electrons. RF EM waves can range from 30 to 300 kHz, 300 kHz to 3 MHz, 3 to 30 MHz, 30 to 300 MHz, 300 MHz to 3 GHZ, 3 to 30 GHz. or 30 to 300 GHz.

A material comprising transmissivity, or a material that is transmissive, to radio frequency electromagnetic waves allows for the effective use of an RFID tag (306) in a cap assembly (500) with a cap (200). Previously, the metal of the cap interfered with the transmission of the RF EM waves, thus prohibiting use of a liner with an RFID tag in a metal cap assembly. This limited the use of liners comprising RFID tags to cap assemblies with plastic caps, which can be coupled to a vial via a screw or snap mechanism, while the crimping mechanisms is specific to metal caps. The ability of the insert (100, 1100) to transmit RF EM waves, as well as cover and protect the liner from contamination and aluminum dust, makes use of a liner comprising an RFID tag in a cap assembly comprising a metal cap possible. Therefore, a user can now utilize the benefits of a liner comprising an RFID tag in applications that require and/or benefit from use of a crimp cap.

In some examples, the material is a first plastic. The first plastic can include a thermosetting plastic, a thermoplastic, or any combination thereof. Examples of plastics include, but are not limited to, phenolics, polyolefins, or any combination thereof. Examples of polyolefins include, but are not limited to, polyethylene, polypropylene, polybutylene, or any combination thereof.

In some examples, the first plastic comprises a first thermoplastic polymer. Thermoplastic polymers, like all polymers, are made up of small molecules, called monomers, which form long chains via the process of polymerization. For example, one thermoplastic polymer chain can comprise thousands of monomers. Thermoplastic polymers include, but are not limited to, polyethylene (PE), polypropylene (PP), polyvinyl chloride (PVC), polystyrene (PS), polyethylene terephthalate (PET), polybutylene terephthalate (PBT), and polyamide (PA).

In some examples, the first thermoplastic polymer comprises polypropylene. Polypropylene is a thermoplastic polymer derived from propylene monomers and can have a formula as shown below. Polypropylene can be produced via chain-growth polymerization. Polypropylene can have a melting point of 320° F.

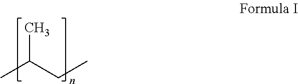

In some examples, the insert (100, 1100) has an average characteristic dimension of from 7.7 mm to 28.3 mm. In further examples, the insert (100, 1100) has an average characteristic dimension of from 7.7 to 9 mm, 9 to 11 mm, 11 to 13 mm, 13 to 15 mm, 15 to 17 mm, 17 to 19 mm, 19 to 21 mm, 21 to 23 mm, 23 to 25 mm, 25 to 27 mm, or 27 to 28.3 mm. In certain examples, the insert (100, 1100) has an average characteristic dimension of from 7.7 to 11 mm, 7.7 to 13 mm, 7.7 to 15 mm, 7.7 to 17 mm, 7.7 to 19 mm, 7.7 to 21 mm, 7.7 to 23 mm, 7.7 to 25 mm, or 7.7 to 27 mm. In specific examples, the insert (100, 1100) has an average characteristic dimension of from 7.7 to 8.3 mm, 10.7 to 11.3 mm, 19.7 to 20.3 mm, or 27.7 to 28.3 mm.

The term “characteristic dimension,” as used herein, refers to the largest straight-line distance between two points in the plane of a cross-sectional shape. Herein, the plane of a cross-sectional shape can be that of a liner or cap, for example. “Average characteristic dimension” generally refers to the statistical mean characteristic dimension. For example, when the liner (300) or cap (200) has a cross-sectional shape that is substantially circular, the average characteristic dimension can refer to the average diameter.

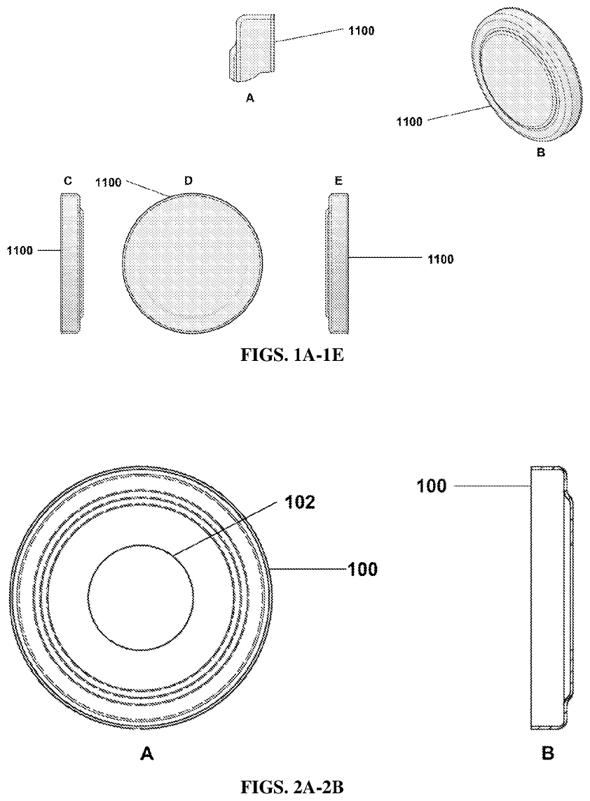

Referring now to FIGS. 1A-1E, FIG. 1A is a portion of a side view of an example insert having no aperture (1100). FIG. 1B is a perspective view of an example insert having no aperture (1100). FIG. 1C is a full side view of an example insert having no aperture (1100). FIG. 1D is a top view of an example insert having no aperture (1100). FIG. 1E is a full side view of an example insert having no aperture (1100).

Referring now to FIGS. 2A-2B, FIG. 2A is a top view of an example insert (100) with an aperture (102). FIG. 2B is a full side view of an example insert (100).

### Cap Assembly

Also provided herein is a cap assembly (500) comprising the insert (100, 1100) discussed herein, a liner (300), and the cap (200), wherein the cap (200) is coupled to the first surface of the insert (100, 1100) and the liner (300) is coupled to the second surface of the insert (100, 1100).

In further examples, the lip surrounds the liner (300). In certain examples, the lip encloses at least a portion of the liner (300). In some examples, the lip can be so dimensioned such that it has substantially the same length as the thickness of the liner. As used herein, a liner (300) can securely seal samples in a container such that the sample is separate from an external environment while simultaneously allowing for extraction of the sample, for example via a syringe (118). A liner (300) can include a septum (302) and a layer (304), wherein the septum (302) is attached to the layer (304).

In some examples, the liner (300) comprises a septum (302). As used herein, a septum (302) refers to a membrane used in techniques for the transfer of substances. In some examples the septum (302) can be made of a rubber. In further examples, the membrane can be chemically resistant. In specific examples, the septum (302) can be used with a syringe (118) to transfer a substance from, for example, a vial (400) to a gas chromatograph, liquid chromatograph, mass spectrometer, or any combination thereof for separation, purification, and/or identification. A septum (302) can be used when transferring a solid, liquid, gas, or any combination thereof. In further examples, the septum (302) has a top surface and a bottom surface, the bottom surface being opposite and spaced apart from the top surface.

In some examples, the septum (302) comprises an elastomer. Elastomers are any material exhibiting elastic or rubber-like properties and can be natural or synthetic. Elastomeric materials (e.g., materials comprising elastomers) include, but are not limited to, foams and sponges, rubbers, cork products, and any combination thereof. Rubbers include, for example, urethanes, chloroprenes, neoprenes, isoprene rubbers, acrylonitrile butadiene rubbers, ethylene propylene rubbers, fluoroelastomers, silicone rubbers, styrene butadiene rubbers, fluorosilicones, and polyisobutylene rubbers (also referred to as “butyl”).

In some examples, the elastomer comprises silicone rubber. Silicone rubber is a durable and resistant elastomer comprising silicone, which comprises silicon, carbon, hydrogen, and oxygen. The silicone rubber comprises a siloxane backbone and an organic moiety bound to the silicon, as per the following general formula (where “R” is the organic moiety):

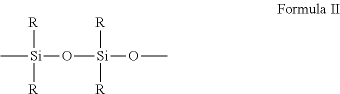

Silicone can have a tensile strength of from 500-2500 psi and an elongation percentage of from 450-900%. Silicone is ozone resistant and can withstand low temperatures (e.g., down to −75° F.) and high temperatures (e.g., up to 500° F.). In some examples, the silicone rubber is a room-temperature vulcanizing silicone rubber.

In some examples, the septum (302) comprises a material that is transmissive to radio frequency electromagnetic waves.

In some examples, the liner (300) further comprises a first layer (304). In further examples, the first layer (304) comprises a second thermoplastic polymer. In certain examples, the liner (300) further comprises a second layer (304). In specific examples, the second layer (304) comprises a third thermoplastic polymer.

Thermoplastic polymers, like all polymers, are made up of small molecules, called monomers, which form long chains via the process of polymerization. For example, one thermoplastic polymer chain can comprise thousands of monomers. Thermoplastic polymers include, but are not limited to, polyethylene (PE), polypropylene (PP), polyvinyl chloride (PVC), polystyrene (PS), polyethylene terephthalate (PET), polybutylene terephthalate (PBT), polyamide (PA), and polytetrafluoroethylene (PTFE).

In further examples, a liquid disposed on the first and/or second thermoplastic polymers has a contact angle of from 0° to 90° with that thermoplastic polymer. Contact angle is a measure of the ability of a liquid to wet the surface of a solid. The contact angle is an angle formed by a liquid at the three-phase boundary where a liquid, gas, and solid intersect. As contact angle decreases, surface energy increases, surface tension decreases, and wettability increases. In some examples, when a contact angle of a liquid with a surface is less than 90°, the wetting of the surface by the liquid is very favorable and the liquid can spread over a large area of the surface. As described herein, a liquid having a contact angle less than 90° with the first and/or thermoplastic polymer can be favorable for bonding that thermoplastic polymer to the elastomer (e.g., for bonding polypropylene or PTFE to silicone).

In some examples, the septum (302) is attached to the first layer (304). In further examples, the septum (302) is attached to the second layer (304). In the liner (300), the layer (304) can be attached to the septum (302). The thermoplastic polymer can be coupled to the elastomer using methods known in the art. For example, the layer (304) comprising thermoplastic polymer can be attached to the septum (302) comprising elastomer via the application of compositions such as primers, prime coats, adhesion promoters, or any combination thereof; these coupling compositions can be dilute solutions comprising silane coupling agents, along with other active ingredients. The compositions are generally liquids and enhance the adhesion and bonding of silicones to a variety of substances. In some examples, these substances can include, but are not limited to, Dow Corning® 3-6060, 92-023, S-2260, or any combination thereof.

In some examples, the first layer (304) has, for example, a third surface and a fourth surface, the fourth surface being opposite and spaced apart from the third surface. In some examples of the liner (300), the septum (302) is disposed on the first layer (304) comprising the second thermoplastic polymer (108) such that a top surface of the septum (302) is disposed on and in physical contact with the third surface of the first layer (304) comprising the second thermoplastic polymer (108). In some examples, the bottom surface of the septum (302) is disposed on the third surface of the first layer (304) comprising the second thermoplastic polymer (108). In further examples, the septum (302) can be disposed on a second layer (304) comprising a third thermoplastic polymer (108), having, for example, a fifth surface and a sixth surface, the fifth surface being opposite and spaced apart from the sixth surface. In certain examples, the septum (302) is disposed on the second layer (304) such that a top surface of the septum (302) is disposed on and in physical contact with the fifth surface of the second layer (304) comprising the third thermoplastic polymer (108), thus resulting in the septum (302) being sandwiched between the first layer (304) of the second thermoplastic polymer (108) and the second layer (304) of the third thermoplastic polymer (108). In some examples, the septum (302) is disposed on the second layer (304) such that the bottom surface of the septum (302) is disposed on and in physical contact with the fifth surface of the second layer (304) comprising the third thermoplastic polymer (108), thus resulting in the septum (302) being sandwiched between the first layer (304) of the second thermoplastic polymer (108) and the second layer (304) of the third thermoplastic polymer (108).

In some examples, the second thermoplastic polymer and third thermoplastic polymer that comprise the first layer (304) and second layer (304), respectively, can be the same thermoplastic polymer, or different thermoplastic polymers. In the examples wherein the second and third thermoplastic polymers are the same, the first layer (304) and second layer (304) are interchangeable, such that either the top surface of the septum (302) can be disposed on either the first layer (304) or second layer (304) and either of the first layer (304) or second layer (304) can be in contact with the insert (100, 1100).

In some examples, the liner (300) further comprises a radio-frequency identification (RFID) tag (306). In further examples, the RFID tag (306) is fixed to the liner (300).

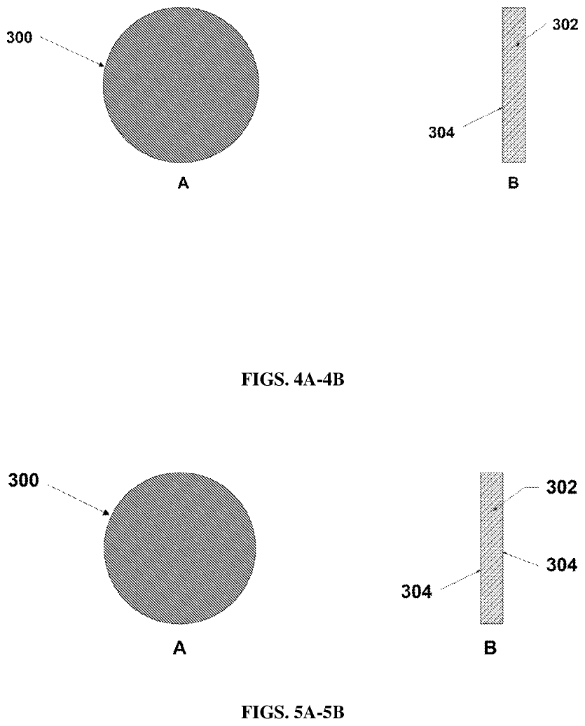

Referring now to FIGS. 4A-4B, FIG. 4A is a top view of an example liner (300). FIG. 4B is a full side view of an example liner (300) comprising a first layer of a thermoplastic polymer (304) and a septum (302).

Referring now to FIGS. 5A-5B, FIG. 5A is a top view of an example liner (300). FIG. 5B is a full side view of an example liner (300) comprising a first layer (304) and a second layer (304) and a septum (302).

An RFID tag (306) is an electronic tag that exchanges data with a radio frequency identification (RFID) reader by using radio waves. RFID tags can also be referred to as RFID chips. In some examples, an RFID tag (306) can be made up of at least two main parts: an antenna, which receives radio frequency (RF) electromagnetic waves, and an integrated circuit (IC), which is used for processing and storing data, as well as modulating and demodulating the radio waves received/sent by the antenna.

The liner (300) can comprise the RFID tag (306). For example, the RFID tag (306) can be fixed to the liner (300) or the RFID tag (306) can be embedded in the liner (300), or more specifically, the septum (302), for example. The RFID tag (306) can be fixed to the liner (300) via any method known in the art. In some examples, the RFID tag (306) is molded to the liner (300). When the liner (300) does not comprise a layer of thermoplastic polymer or comprises only a first layer of the second thermoplastic polymer, then the RFID tag (306) can be molded to the top surface of the septum (302). When the liner (300) comprises a first layer of the second thermoplastic polymer and a second layer of the third thermoplastic polymer, then the RFID tag (306) can be molded to the first layer or second layer.

In some examples, the RFID tag (306) is fixed to the liner (300) such that the RFID tag (306) is sandwiched between the cap (200) and the liner (300). More specifically, if the liner (300) does not comprise a layer of thermoplastic polymer or comprises only one layer of thermoplastic polymer, the RFID tag (306) is sandwiched between the insert (100, 1100) and the top surface of the septum (302) of the liner (300) such that the RFID tag (306) is substantially parallel to the insert (100, 1100) and the septum (302). When the liner (300) comprises a first layer and a second layer of thermoplastic polymer, then the RFID tag (306) is sandwiched between the insert (100, 1100) and either of the first layer (304) or second layer (304) of thermoplastic polymer. Fixing the RFID tag (306) to the liner (300) permanently associates the RFID tag (306) with the liner (300), cap assembly (500), cap and vial assembly (600), and/or the sample.

In examples wherein the RFID tag (306) is embedded in the liner (300), embed refers to at least partially enclosing in a material. Herein, embedding an RFID tag (306) into the liner (300), or more specifically the septum (302), can protect the integrity of the RFID tag (306) and permanently associates the RFID tag (306) with the liner (300), cap assembly (500), cap and vial assembly (600), and/or the sample.

Further examples of a liner (300) comprising an RFID tag (306) are disclosed in U.S. Pat. No. 10,035,631, which is incorporated herein by reference.

The RFID tag (306) in the liner (300) utilizes transmission of radio frequency electromagnetic waves to transmit sample identifying data. Use of the insert (100, 1100) discussed herein allows for maximum transmissivity of the RF EM waves corresponding to the RFID tag (306) because the metal that can interfere with the RF EM waves is replaced in part by the insert (100, 1100).

The cap assembly (500) is a modular assembly, wherein the insert (100, 1100), liner (300), and cap (200) are securely in contact with one another, touching without movement. In some examples, the liner (300) and/or the cap (200) can be coupled to the insert (100, 1100) using methods known in the art, for example as disclosed in U.S. Pat. Nos. 5,647,939 and/or 6,234,335. As used herein, “coupled” can include “removably coupled”, wherein the liner (300) and/or cap (200) are coupled to the insert (100, 1100) such that the cap assembly (500) is subject to disassembly. In some examples, the assembly can be referred to as “press-fit”.

As used herein, a cap (200) is a lid for an object such as a vial (400). Herein, the cap (200) can seal to a vial (400), for example to prevent evaporation and/or contamination of a sample contained within the vial (400). A cap (200) as disclosed herein can, for example, be a crimp-on cap, meaning that the cap (200) can crimp onto the vial (400).

In some examples, the cap (200) has a cross-sectional shape, wherein the cross-sectional shape is substantially circular. In further examples, the cap (200) has an average characteristic dimension of from 8 mm to 28 mm. In certain examples, the cap (200) has an average characteristic dimension of from 8 to 10 mm, 8 to 12 mm, 8 to 14 mm, 8 to 16 mm, 8 to 18 mm, 8 to 20 mm, 8 to 22 mm, 8 to 24 mm, 8 to 26 mm, or 8 to 28 mm. In specific examples, the cap (200) has an average characteristic dimension of from 8 to 10 mm, 10 to 12 mm, 12 to 14 mm, 14 to 16 mm, 16 to 18 mm, 18 to 20 mm, 20 to 22 mm, 22 to 24 mm, 24 to 26 mm, or 26 to 28 mm. In some examples, the cap (200) has an average characteristic dimension of from 8 to 12 mm, 12 to 16 mm, 16 to 20 mm, 20 to 24 mm, or 24 to 28 mm.

In certain examples, the cap (200) has an average characteristic dimension of 8 mm. In specific examples, the cap (200) has an average characteristic dimension of 11 mm. In some examples, the cap (200) has an average characteristic dimension of 20 mm.

In some examples, the cap (200) comprises metal. A metal is any of a class of substances characterized by high electrical and thermal conductivity, and in some examples, malleability, ductility, and high reflectivity of light. Metals include, but are not limited to, aluminum, copper, brass, magnesium, tin, lead, bronze, zinc, or any combination thereof.

In some examples, the metal is malleable. Malleability describes the ability of a metal to be distorted below compression. Malleable metals therefore allow the cap (200) to be distorted, such as via a crimping technique.

In some examples, the metal comprises aluminum. Aluminum is silvery white in color, lightweight, highly resistant to corrosion, malleable and ductile, and has a low density. A cap (200) described herein can be made of aluminum, as in some examples, the cap (200) is sealed to a vial (400) via a crimping mechanism, which utilizes the malleability and ductility of aluminum.

In some examples, the cap (200) defines an opening (202) proximate the RFID tag (306). In further examples, the opening (202) has an area of from 10% to 80% of the area of the cap (200). In certain examples, the opening (202) has an area of from 10% to 45%, or 45% to 80% of the area of the cap (200). In specific examples, the opening (202) has an area of from 10% to 30%, 10% to 50%, or 10% to 70% of the area of the cap (200). In some examples, the opening has an area of from 10% to 20%, 20% to 30%, 30% to 40%, 40% to 50%, 50% to 60%, 60% to 70%, or 70% to 80% of the area of the cap (200). In further examples, the opening (202) has an area of from 10% to 25%, 10% to 35%, 10% to 45%, 10% to 55%, 10% to 65%, or 10% to 75% of the area of the cap (200). In certain examples, the opening (202) has an area of from 25% to 35%, 25% to 45%, 45% to 55%, 55% to 65%, or 65% to 75% of the area of the cap (200).

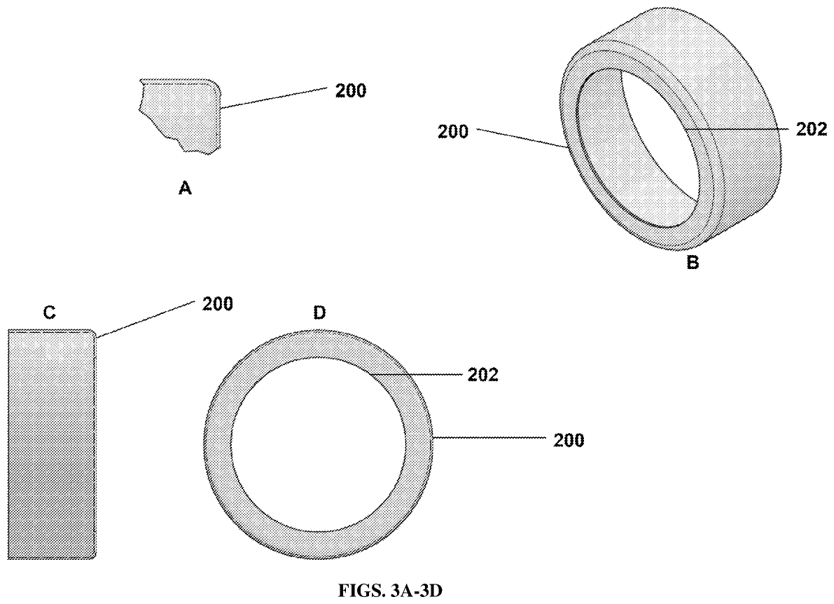

Referring now to FIGS. 3A-3D, FIG. 3A is a portion of a side view of an example cap (200), wherein the cap comprises metal and secures to a vial via a crimping mechanism. FIG. 3B is a perspective view of an example cap (200) with an opening (202). FIG. 3C is a full side view of an example cap (200). FIG. 3D is a top view of an example cap (200) with an opening (202).

### Cap and Vial Assembly

Also provided herein is a cap and vial assembly (600) comprising the cap assembly (500) discussed herein, and a vial (400), wherein the cap assembly (500) is configured to be secured to the vial (400).

As used herein, a vial (400) is a closable vessel that can hold a solid, liquid, gas, or any combination thereof. A vial (400) can be made of any suitable material. A vial (400) can include, but is not limited to, a container, a well plate of any capacity, an ampoule, or a bottle. In some examples, the vial is a 96-well plate. A 96-well plate refers to a plate with multiple (e.g., 96) sample wells, often arranged in a rectangular matrix. A 96-well plate can be used in virology, serology, microbiology, and/or life science and drug discovery applications.

In some examples, the vial (400) can have a volume of from 1 mL to 500 mL (e.g., 1 to 50 mL, 50 to 100 mL, 100 to 150 mL, 150 to 200 mL, 200 to 250 mL, 250 to 300 mL. 300 to 350 mL, 350 to 400 mL, 400 to 450 mL, or 450 to 500 mL).

A vial (400) can be made of any suitable material. For example, the vial (400) can be made of materials that include, but are not limited to, plastic, glass, or any combination thereof.

In some examples, the vial (400) comprises glass. The glass used to make the vial (400) can include, but is not limited to, soda-lime glass, borosilicate glass, or any combination thereof.

In some examples, the glass comprises borosilicate glass. Borosilicate glass is a type of glass with silica and boron trioxide as the main glass-forming constituents. Borosilicate glasses have low coefficients of thermal expansion (e.g., approximately 3×10⁻⁶ K⁻¹ at 20° C.), making them more resistant to thermal shock than any other common glass. Such glass is subjected to less thermal stress and can withstand temperature differentials without fracturing of about 165° C. (300° F.).

In some examples, the vial (400) comprises a second plastic. Examples of plastics that can be used to make a vial (400) include, but are not limited to, acrylics, high-density polyethylene, or any combination thereof. In some examples, the vial (400) can be made of a pharmaceutical-grade plastic.

In some examples, the cap assembly (500) is configured to be secured to the vial (400) with a crimping mechanism. As used herein, a “crimping mechanism” refers to a mechanism wherein an object made with malleable metal is attached to a container, such as a vial (400), by bending the metal over the outer edge of the vial (400). This can be done with a device such as a vial crimper. Herein, the crimping mechanism is utilized as a means of sealing a cap assembly (500) comprising metal to a vial (400) such that the contents of the vial (400) are sealed within the vial (400), for example to minimize or prevent evaporation and/or contamination, and entails placing a cap assembly (500) comprising metal on a vial (400) and crimping the cap assembly (500) to the vial (400) using a crimping tool.

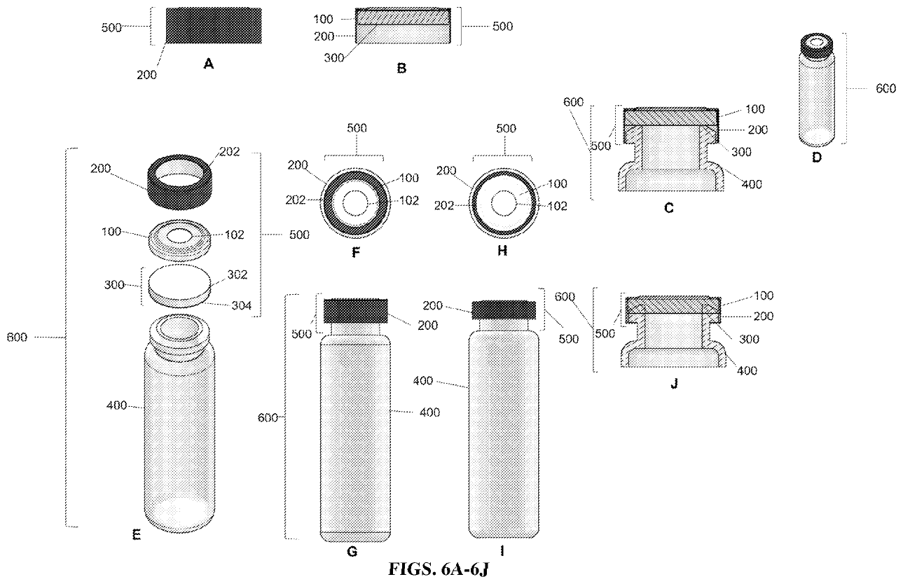

Referring now to FIGS. 6A-6J, FIG. 6A is a side view of an example cap assembly (500) comprising an example cap (200) comprising metal. FIG. 6B is cross-sectional side view of an example cap assembly (500) comprising an example insert (100), an example cap (200) comprising metal, and an example liner (300). FIG. 6C is a cross-sectional side view of an example cap and vial assembly (600) comprising an example vial (400) and an example cap assembly (500), wherein the example cap assembly includes an example insert (100), an example cap (200) made of metal, and an example liner (300). FIG. 6D is a perspective view of an example cap and vial assembly (600). FIG. 6E is an exploded perspective view of an example cap and vial assembly (600) comprising an example vial (400) made of glass and an example cap assembly (500), including an example cap (200) made of metal, which has an example opening (202), an example insert (100) made of plastic, with an example aperture (102), and an example liner (300), comprising an example septum (302) and an example first layer (304). FIG. 6F is a top view of an example cap assembly (500), comprising an example cap (200) with an example opening (202), and an example insert (100) made of plastic and having an aperture (102). FIG. 6G is a side view of an example cap and vial assembly (600), comprising an example vial (400) and an example cap assembly (500) comprising an example cap (200) made of metal. FIG. 6H is a top view of an example cap assembly (500), comprising an example cap (200) with an example opening (202), and an example insert (100) made of plastic and having an aperture (102). FIG. 6I is a side view of an example cap and vial assembly (600), comprising an example vial (400) and an example cap assembly (500) comprising an example cap (200) made of metal. FIG. 6J is a cross-sectional side view of an example cap and vial assembly (600) comprising an example vial (400) and an example cap assembly (500), wherein the example cap assembly includes an example insert (100), an example cap (200) made of metal, and an example liner (300).

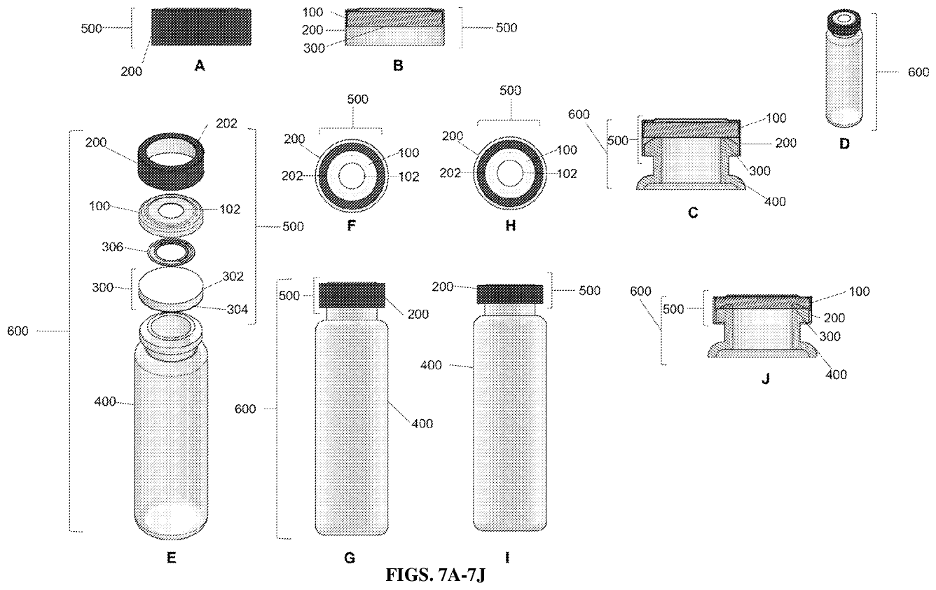

Referring now to FIGS. 7A-7J. FIG. 7A is a side view of an example cap assembly (500) comprising an example cap (200) comprising metal. FIG. 7B is cross-sectional side view of an example cap assembly (500) comprising an example insert (100), an example cap (200) comprising metal, and an example liner (300). FIG. 7C is a cross-sectional side view of an example cap and vial assembly (600) comprising an example vial (400) and an example cap assembly (500), wherein the example cap assembly includes an example insert (100), an example cap (200) made of metal, and an example liner (300). FIG. 7D is a perspective view of an example cap and vial assembly (600). FIG. 7E is an exploded perspective view of an example cap and vial assembly (600) comprising an example vial (400) made of glass and an example cap assembly (500), including an example cap (200) made of metal, which has an example opening (202), an example insert (100) made of plastic, with an example aperture (102), an RFID tag (306), and an example liner (300), comprising an example septum (302) and an example first layer (304). FIG. 7F is a top view of an example cap assembly (500), comprising an example cap (200) with an example opening (202), and an example insert (100) made of plastic and having an aperture (102). FIG. 7G is a side view of an example cap and vial assembly (600), comprising an example vial (400) and an example cap assembly (500) comprising an example cap (200) made of metal. FIG. 7H is a top view of an example cap assembly (500), comprising an example cap (200) with an example opening (202), and an example insert (100) made of plastic and having an aperture (102). FIG. 7I is a side view of an example cap and vial assembly (600), comprising an example vial (400) and an example cap assembly (500) comprising an example cap (200) made of metal. FIG. 7J is a cross-sectional side view of an example cap and vial assembly (600) comprising an example vial (400) and an example cap assembly (500), wherein the example cap assembly includes an example insert (100), an example cap (200) made of metal, and an example liner (300).

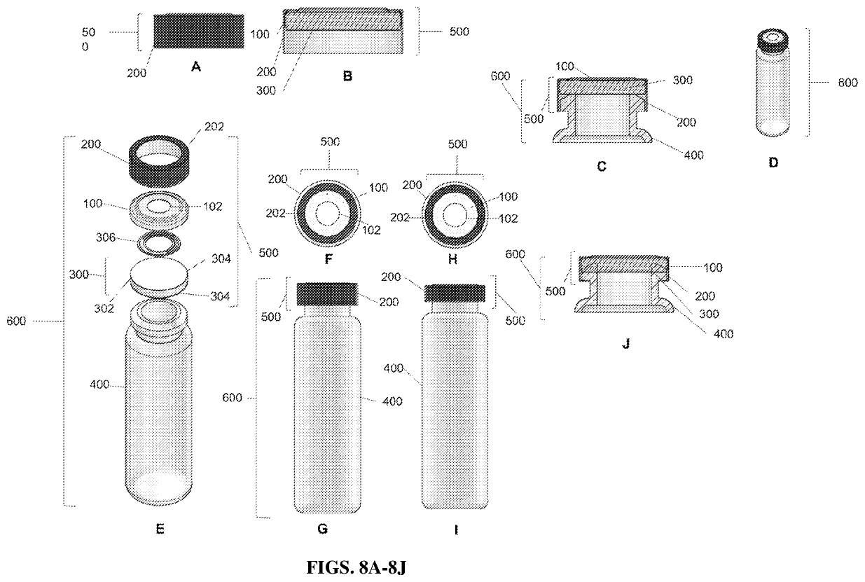

Referring now to FIGS. 8A-8J, FIG. 8A is a side view of an example cap assembly (500) comprising an example cap (200) comprising metal. FIG. 8B is cross-sectional side view of an example cap assembly (500) comprising an example insert (100), an example cap (200) comprising metal, and an example liner (300). FIG. 8C is a cross-sectional side view of an example cap and vial assembly (600) comprising an example vial (400) and an example cap assembly (500), wherein the example cap assembly includes an example insert (100), an example cap (200) made of metal, and an example liner (300). FIG. 8D is a perspective view of an example cap and vial assembly (600). FIG. 8E is an exploded perspective view of an example cap and vial assembly (600) comprising an example vial (400) made of glass and an example cap assembly (500), including an example cap (200) made of metal, which has an example opening (202), an example insert (100) made of plastic, with an example aperture (102), an RFID tag (306), and an example liner (300), comprising an example septum (302), an example first layer (304), and an example second layer (304). FIG. 8F is a top view of an example cap assembly (500), comprising an example cap (200) with an example opening (202), and an example insert (100) made of plastic and having an aperture (102). FIG. 8G is a side view of an example cap and vial assembly (600), comprising an example vial (400) and an example cap assembly (500) comprising an example cap (200) made of metal. FIG. 8H is a top view of an example cap assembly (500), comprising an example cap (200) with an example opening (202), and an example insert (100) made of plastic and having an aperture (102). FIG. 8I is a side view of an example cap and vial assembly (600), comprising an example vial (400) and an example cap assembly (500) comprising an example cap (200) made of metal. FIG. 8J is a cross-sectional side view of an example cap and vial assembly (600) comprising an example vial (400) and an example cap assembly (500), wherein the example cap assembly includes an example insert (100), an example cap (200) made of metal, and an example liner (300).

### Methods

### Method of Tracking a Sample

The present disclosure also provides for a method of tracking a sample, wherein the sample is contained within a container comprising the cap assembly (500) as disclosed herein, or the cap and vial assembly (600) as disclosed herein, the method comprising entering sample identifying data into a database associated with the RFID tag (306), and scanning the RFID tag (306) to obtain the sample identifying data, further wherein the liner (300) comprises an RFID tag (306).

Tracking can refer to following and noting the changes, trends, patterns, developments, and/or progression of a sample's characteristics, such as the contents, properties, and/or the location, for example. Tracking can be used for purposes that include but are not limited to storage, research development, sample analysis, or quality testing.

The sample identifying data can include the sample characteristics discussed above, which in some examples, uniquely identify the sample(s). Sample identifying data can include, but is not limited to, analysis results, properties, or location, for example. The data can include any information as selected by the user.

As used herein, the database can maintain data about the sample as defined by the user. The RFID tag (306) data uniquely identifies the sample in the database based on the maintained data.

A sample can include a liquid, gas, or solid. In particular, samples can include but are not limited to environmental samples, such as water or dirt, pharmaceutical or petrochemical samples, or biological samples.

In some examples, the sample comprises a biological sample. Biological samples can include biological specimens such as blood, urine, tissue, saliva, or any combination thereof, for example.

### Method of Analyzing a Sample

Also provided herein, is a method of analyzing a sample using an analytical instrument, wherein the sample is contained within a container comprising the insert (100, 1100) as disclosed herein, the cap assembly (500) as disclosed herein, or the cap and vial assembly (600) as disclosed herein, the method comprising penetrating the liner (300) with a syringe to remove a portion of the sample and testing the portion of the sample using the analytical instrument. In further examples, the sample comprises a biological sample.

In some examples, the method further comprises penetrating the insert (100, 1100) with the syringe to remove a portion of the sample. In further examples, the method further comprises removing one or more portions of the sample by penetrating the liner (300) with the syringe from 1 to 20 times.

As used herein, a syringe is a reciprocating pump comprising a plunger that fits tightly within a cylindrical tube having a longitudinal axis. The plunger can be linearly translocated (e.g., pulled and/or pushed) axially along the inside of the tube, allowing the syringe to take in and expel liquid or gas through a discharge orifice at an open end of the tube. The open end of the tube can be fitted with, for example, a hypodermic needle, a nozzle, and/or tubing to direct flow into and out of the syringe. As used herein, “syringe” and “needle” are used interchangeably. Further, the syringe can include a syringe or needle as connected to an auto-sampler device, wherein an auto-sampler is a device that automatically loads collected samples into a laboratory instrument (e.g., an analytical instrument), such as a gas chromatograph, liquid chromatograph, mass spectrometer, or any combination thereof. The syringe can be single-use or multi-use.

Further, the syringe can have any suitable size and/or volume. In some examples, the syringe can have a volume of from 1 mL to 50 mL (e.g., 1 mL to 10 mL, 10 mL to 20 mL, 20 mL to 30 mL, 30 mL to 40 mL, or 40 mL to 50 mL). In further examples, the syringe can have a volume of from 1 mL to 25 mL or 25 mL to 50 mL (e.g., 1 mL to 5 mL, 1 mL to 10 mL, 1 mL to 15 mL, 1 mL to 20 mL, 1 mL to 25 mL, 1 mL to 30 mL, 1 mL to 35 mL, 1 mL to 40 mL, 1 mL to 45 mL, or 1 mL to 50 mL).

In some examples, the syringe can have a volume of from 5 to 1000 μL. In further examples, the syringe can have a volume of from 5 to 100, 100 to 200, 200 to 300, 300 to 400, 400 to 500, 500 to 600, 600 to 700, 700 to 800, 800 to 900, or 900 to 1000 μL. In certain examples, the syringe can have a volume of 5 μL or more, 10 μL or more, 25 μL or more. 50 μL or more, 100 μL or more, 250 μL or more, 500 μL or more, or 1000 μL or more. A syringe having a volume of from 5 to 1000 μL can also be referred to as a “micro syringe.”

In certain examples, the analytical instrument is a gas chromatograph, liquid chromatograph, mass spectrometer, or any combination thereof.

Gas chromatography is an analytical technique used to separate chemical components in a mixture and detect them to determine their presence, absence, and/or concentration. The chemical components subject to detection can include organic molecules or gases. Gas chromatography can be used for quality control in the manufacture of products ranging from cars to chemicals, such as petrochemicals or pharmaceuticals, research, or safety and monitoring of environmental samples, microplastics, or food. Gas chromatography can be performed on a gas chromatograph (GC). A GC operates by transporting the sample molecules from a solid, liquid, and/or gas in a carrier gas through a heated analytical column and into a detector which responds to the chemical components eluting from the column to produce a signal, which is recorded by appropriate software to produce a chromatogram. The sample can be extracted via a syringe and/or an autosampler. When a sample is not a gas, then the chemical components of the sample are first vaporized.

Liquid chromatography is an analytical technique in which the sample ions or molecules are dissolved in a liquid mobile phase. Liquid chromatography can be performed on a liquid chromatograph (LC) which operates by transporting the sample in the liquid mobile phase through a column or plane packed with a stationary phase. Different solutes interact with the stationary phase to different degrees due to differences in ion-exchange, adsorption, partitioning, and/or size, thus separating the compounds. The transit time of the solute through the column is determined based on these differences. The sample can be extracted into the liquid chromatograph via a syringe and/or an autosampler.

Gas chromatographs and/or liquid chromatographs can further be equipped with a mass spectrometer. Mass spectrometry is an analytical tool useful for measuring the mass-to-charge ratio (m/z) of one or more molecules present in a sample. A mass spectrometer (MS) converts individual molecules from a sample into ions so that they can be moved and manipulated by internal electric and magnetic fields. The mass spectrometer comprises three components: the ion source, mass analyzer, and detector. The ion source ionizes the sample. In some examples, the ion source ionizes the sample to cations by loss of an electron. In further examples, the ion source ionized the sample to anions. The mass analyzer sorts and separates the ions according to their mass and charge. The detector measures the separated ions and displays the results on a chart. In some examples, a mass spectrometer may be utilized in tandem with a gas chromatograph and/or liquid chromatograph.

In some examples, the liner (300) is penetrated with the syringe via an auto-sampling device. An auto-sampler is a device that automatically loads collected samples into a laboratory instrument (e.g., an analytical instrument), such as a gas chromatograph, liquid chromatograph, mass spectrometer, or any combination thereof. The syringe (118) can be single-use or multi-use.

A number of embodiments of the disclosure have been described. Nevertheless, it will be understood that various modifications may be made without departing from the spirit and scope of the invention. Accordingly, other embodiments are within the scope of the following claims.

Other advantages which are obvious, and which are inherent to the invention, will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The methods and products of the appended claims are not limited in scope by the specific methods and products described herein, which are intended as illustrations of a few aspects of the claims and any methods and products that are functionally equivalent are intended to fall within the scope of the claims. Various modifications of the methods and products in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

1. An insert for transmitting electromagnetic waves, the insert comprising:
a substantially circular disc comprising a first surface and a second surface opposite and spaced apart from the first surface; and
a lip extending from the disc and surrounding a perimeter of the disc;
wherein the insert comprises a material that can be penetrated by a syringe.

2. The insert of claim 1, wherein the insert has a Shore D hardness of from 20 to 80.

3. The insert of claim 1, wherein the insert further comprises an aperture, the aperture extending through the substantially circular disc from the first surface to the second surface.

4. The insert of claim 3, wherein the aperture has a cross-sectional shape that is substantially circular.

5. The insert of claim 3, wherein the aperture has an area of from 10% to 80% of the area of the first surface.

6. The insert of claim 3, wherein the aperture has an average characteristic dimension of from 0 millimeters (mm) to 16 mm.

7. The insert of claim 1, wherein the insert is a single continuous structure comprising the disc and the lip.

8. The insert of claim 1, wherein the lip is substantially perpendicular to the first surface of the disc.

9. The insert of claim 1, wherein a thickness of the disc varies across the diameter.

10. The insert of claim 1, wherein the insert has an average thickness of from 0.1 mm to 0.5 mm.

11. The insert of claim 1, wherein the material is transmissive to radio frequency electromagnetic waves.

12. The insert of claim 1, wherein the insert has a transmissivity to radio frequency electromagnetic waves.

13. The insert of claim 1, wherein the material is a first plastic.

14. The insert of claim 13, wherein the first plastic comprises a first thermoplastic polymer.

15. The insert of claim 14, wherein the first thermoplastic polymer comprises polypropylene.

16. The insert of claim 1, wherein the insert has an average characteristic dimension of from 7.7 mm to 28 mm.

17. A cap assembly comprising the insert of claim 1, a liner, and the cap, wherein the cap is coupled to the first surface of the insert and the liner is coupled to the second surface of the insert.

18.-40. (canceled)

41. A cap and vial assembly comprising the cap assembly of claim 17, and a vial, wherein the cap assembly is configured to be secured to the vial.

42.-46. (canceled)

47. A method of tracking a sample, wherein the sample is contained within a container comprising the cap assembly of claim 17, wherein the method comprises entering sample identifying data into a database associated with the RFID tag, and scanning the RFID tag to obtain the sample identifying data, further wherein the liner comprises an RFID tag.

48. (canceled)

49. A method of analyzing a sample using an analytical instrument, wherein the sample is contained within a container comprising the cap assembly of claim 17, the method comprising penetrating the liner with a syringe to remove a portion of the sample and testing the portion of the sample using the analytical instrument.

50.-54. (canceled)
